(19) United States
(12) Patent Application Publication
(10) Pub. No.: US 2026/0138263 A1
(43) Pub. Date: May 21, 2026

(54) TOOLSET ORGANIZER

(71) Applicant: Bryan Hickey, Ninilchik, AK (US)

(72) Inventor: Bryan Hickey, Ninilchik, AK (US)

(21) Appl. No.: 19/429,333

(22) Filed: Dec. 22, 2025

Related U.S. Application Data
(63) Continuation-in-part of application No. 18/885,549, filed on Sep. 13, 2024, now Pat. No. 12,521,865.
Application No. 18/885,549 is a continuation-in-part of application No. 17/819,148, filed on Aug. 11, 2022, now Pat. No. 12,115,647.

(51) Int. Cl. B25H 3/04

(52) U.S. Cl. CPC B25H 3/04

(57) ABSTRACT

A first connector of a toolset organizer for organizing sockets includes a first male polygon section connector body along an axis, the first male polygon section connector body sized to receive a first socket; a second male polygon section connector body along the axis, the second male polygon section connector body sized to receive a second socket; and a first flange along the axis between the first male polygon section connector body and the second male polygon section connector body, the first flange of diameter greater than that of the first male polygon section connector body and the second male polygon section connector body.

### CROSS-REFERENCE TO RELATED APPLICATION(S)

This application claims the priority as a continuation-in-part of U.S. Nonprovisional Ser. No. 18/858,549(012362 -HIC) filed Sep. 13, 2024 which is a continuation-in-part of U.S. Nonprovisional Ser. No. 17/819,148(01609 -HIC) filed Aug. 11, 2022. Each of the aforementioned patent applications, and any applications related thereto, are herein incorporated by reference in their entirety.

### FIELD

The present application generally relates to a toolset organizer that organizes sockets for socket wrenches.

### BACKGROUND

Toolboxes often contain various tools, however, often become somewhat unorganized. Although wrench trays, racks, or compartment slots facilitate organization of tools, these devices may be bulky and waste space within the toolbox and not allow for varying tools to be organized/secured.

### SUMMARY

A first connector of a toolset organizer for organizing sockets according to one disclosed non-limiting embodiment of the present disclosure includes a first male polygon section connector body along an axis, the first male polygon section connector body sized to receive a first socket; a second male polygon section connector body along the axis, the second male polygon section connector body sized to receive a second socket; and a first flange along the axis between the first male polygon section connector body and the second male polygon section connector body, the first flange of diameter greater than that of the first male polygon section connector body and the second male polygon section connector body.

A further embodiment of any of the foregoing embodiments of the present disclosure includes the first flange includes a magnetic material.

A further embodiment of any of the foregoing embodiments of the present disclosure includes a magnet within the first flange.

A further embodiment of any of the foregoing embodiments of the present disclosure includes a multiple of magnets within the first flange.

A further embodiment of any of the foregoing embodiments of the present disclosure includes the first male polygon section connector body is of a size different than the second male polygon section connector body.

A further embodiment of any of the foregoing embodiments of the present disclosure includes the first socket is of a size different than the second socket.

A further embodiment of any of the foregoing embodiments of the present disclosure includes the first male polygon section connector body is sized to receive a first socket via an interference fit and the second male polygon section connector body is sized to receive a second socket via an interference fit.

A further embodiment of any of the foregoing embodiments of the present disclosure includes the first male polygon section connector body includes a first number of sides and the second male polygon section connector body includes a second number of sides different than the first number of sides.

A further embodiment of any of the foregoing embodiments of the present disclosure includes the first male polygon section connector body includes six sides and the second male polygon section connector body includes four sides.

A toolset organizer for organizing sockets according to one disclosed non-limiting embodiment of the present disclosure includes a first of a multiple of connectors each comprising a first flange along an axis between a first male polygon section connector body and a second male polygon section connector body, the first flange of a diameter greater than that of the first male polygon section connector body and the second male polygon section connector body, the first male polygon section connector body is sized to receive a first socket; the second male polygon section connector body is sized to receive a second socket different in size than the first socket; and a second of the multiple of connectors each comprising a second flange along the axis between a third male polygon section connector body and a fourth male polygon section connector body, the second flange of a diameter greater than that of the third male polygon section connector body and the fourth male polygon section connector body, the third male polygon section connector body of the same size as the second male polygon section connector body.

A further embodiment of any of the foregoing embodiments of the present disclosure includes each of the first male polygon section connector body and the second male polygon section connector body includes a hexagon different in size to receive only a single respective socket.

A further embodiment of any of the foregoing embodiments of the present disclosure includes first flange and the second flange are of an equivalent diameter.

A further embodiment of any of the foregoing embodiments of the present disclosure includes the first flange and the second flange each includes a magnetic material.

A further embodiment of any of the foregoing embodiments of the present disclosure includes first flange and the second flange each contain a magnet.

A further embodiment of any of the foregoing embodiments of the present disclosure includes first flange and the second flange each contain a multiple of magnets.

A further embodiment of any of the foregoing embodiments of the present disclosure includes the first male polygon section connector body is of a size different than the second male polygon section connector body.

A further embodiment of any of the foregoing embodiments of the present disclosure includes the third male polygon section connector body is of a size different than the fourth male polygon section connector body.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1A is a top exploded view of a toolset organizer with a multiple of connectors according to one disclosed non-limiting embodiment.

FIG. 1B is a bottom exploded view of a toolset organizer with a multiple of connectors according to one disclosed non-limiting embodiment.

FIG. 2A is a top assembled view of a toolset organizer with a multiple of connectors and sockets connected together according to one disclosed non-limiting embodiment.

FIG. 2B is a bottom assembled view of a toolset organizer with a multiple of connectors and sockets connected together according to one disclosed non-limiting embodiment.

FIG. 3A is a side partial phantom view of a connector according to one disclosed non-limiting embodiment.

FIG. 3B is a perspective view of the connector of FIG. 3A.

FIG. 4 is a perspective view of a connector according to another disclosed non-limiting embodiment.

FIG. 5 is a perspective view of a connector according to another disclosed non-limiting embodiment.

### DETAILED DESCRIPTION

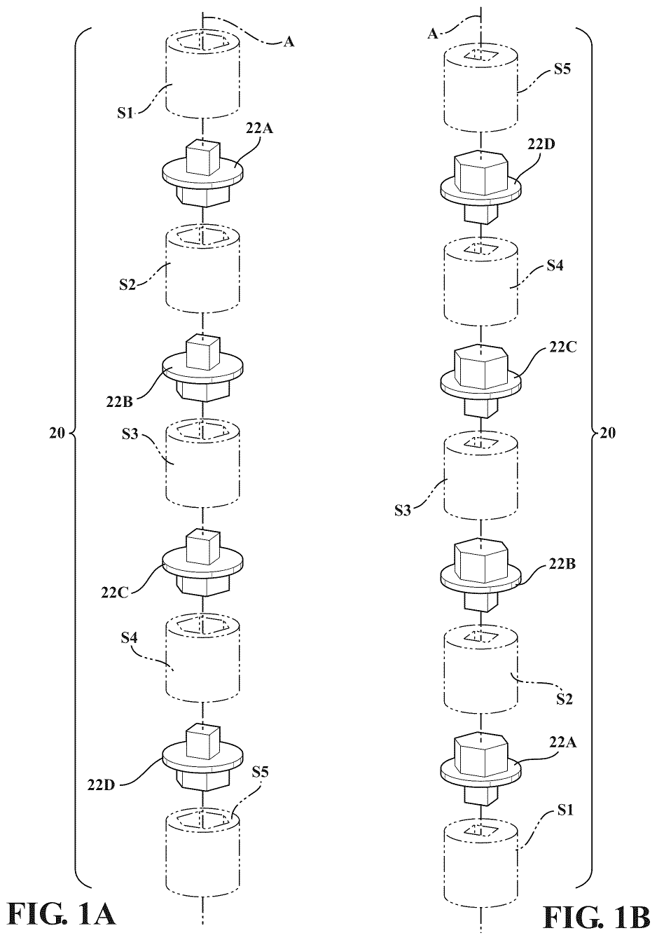

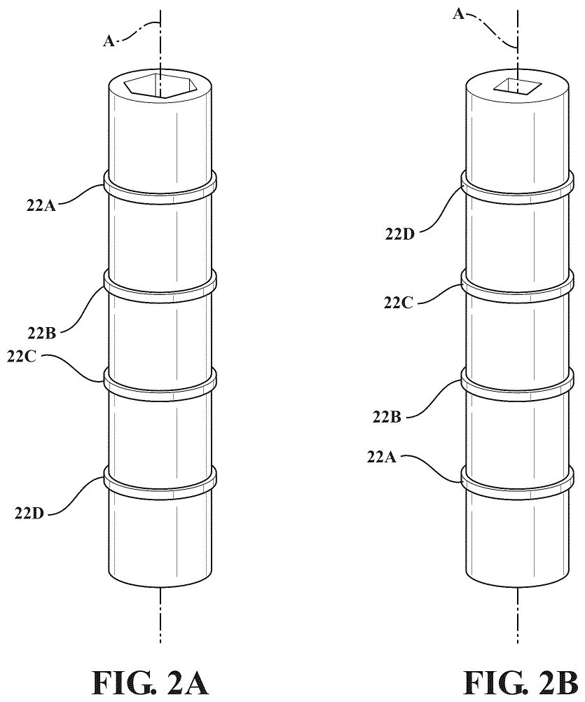

FIGS. 1A and 1B illustrate an example embodiment of the toolset organizer 20. The toolset organizer 20 includes a multiple of connectors 22A, 22B, 22C, 22D . . . 22n, each of which are connectable together vi an intermediately located socket S1, S2, S3, S4, Sn (FIGS. 2A and 2B). Although a particular number of connectors are illustrated in the disclosed embodiment, it would be appreciated that any number thereof may form the toolset organizer 20.

Each connector may be magnetically and/or friction or interference fit to essentially “snap” into an adjacent socket to retain a multiple thereof in a convenient stack. Each connector 22A, 22B, 22C, 22D . . . 22n may be progressively sized to accommodate a full socket set. The toolset organizer 20 provides ease of socket accessibility, identification, transportation, and storage.

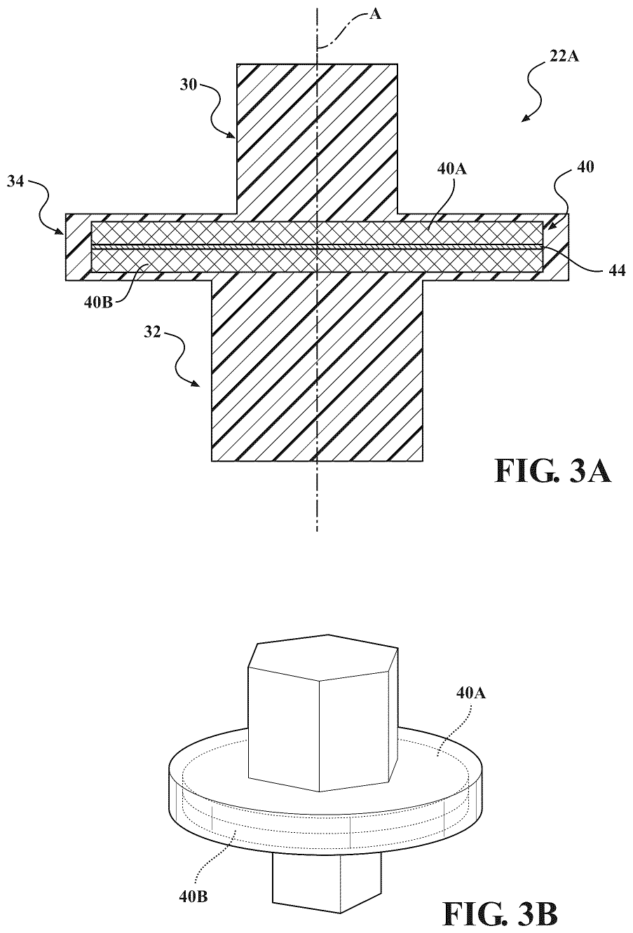

With reference to FIG. 3A, the first connector 22A is exemplary of each of the connectors. The first connector 22A generally includes a first male polygon section 30 along a longitudinal axis A, a second male polygon section 32 along the longitudinal axis A, and a first flange 34 along the axis A between the first male polygon section connector body 30 and the second male polygon section connector body 32.

The first male polygon section 30 is sized to receive the first socket S1. The first male polygon section 30, in one embodiment, may include four sides to fit within one end of the first socket S1. That is, the first male polygon section 30 is sized to receive the socket wrench end of the socket S1. In this embodiment, the first male polygon section 30 may extend for a length along axis A for a distance less than half that of the first socket S1 so that the first flange 34 abuts the socket S1. In one embodiment, the first male polygon section 30 may provide a friction or interference fit with the first socket S1.

The second male polygon section 32 is sized to receive a second socket S2. The second male polygon section 32, in one embodiment, may include six sides to securely fit within an opposite end of the first socket S1. That is, the second male polygon section 32 is sized to receive the tool end of the socket S1. In this embodiment, the second male polygon section 32 may extend for a length along axis A for a distance less than half that of the first socket S1 so that the first flange 34 abuts the socket S1. In one embodiment, the second male polygon section 32 may provide a friction or interference fit with the second socket S2.

The first flange 34 may be of a diameter greater than that of the first male polygon section connector body 30 and the second male polygon section connector body 32. In embodiments, the first flange 34 may be of a diameter greater than, or equal to, the diameter of the largest socket S1, S2, S3, S4, Sn.

In one embodiment, the first flange 34 may include a magnetic material 40. For example, the first flange 34 may include a first and second disk shaped magnetic material 40A, 40B with a non-magnetic separator 44 therebetween (also shown in FIG. 3B). The magnetic material 40 is oriented to magnetically retain the respective socket S1, S2, S3, S4, Sn to the associated connectors 22A, 22B, 22C, 22D . . . 22n.

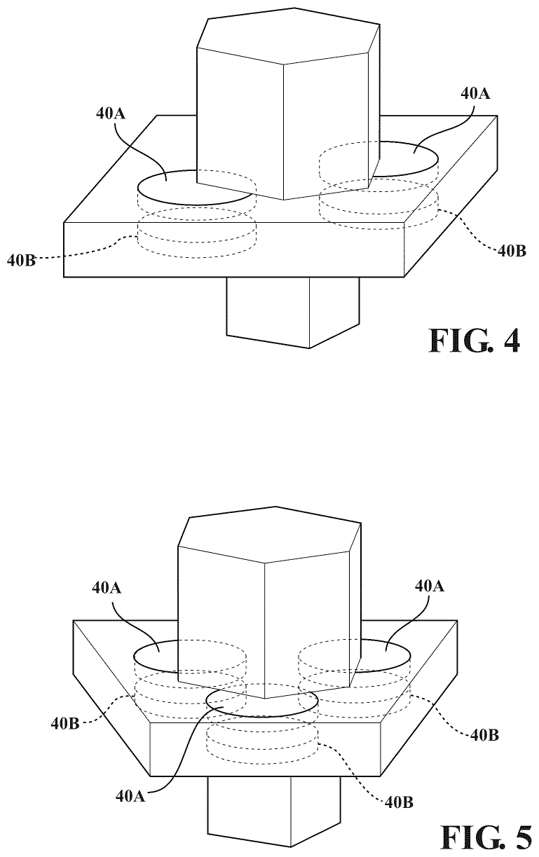

In another embodiment, the first flange 34 may include a multiple of magnets 40 within the first flange 34 (four shown in FIG. 4; six shown in FIG. 5). Various magnet arrangements may be arranged within the first flange 34 to assure that the adjacent sockets are drawn toward the respective flange.

In embodiments, the flanges may include markings to identify to which sockets the connectors 22A, 22B, 22C, 22D . . . 22n are attachable.

In embodiments, the flanges may be of various non-circular shapes to reduce rolling on a surface.

Alternatively, the connectors 22A, 22B, 22C, 22D . . . 22n may be sized to receive a multiple of socket S1, S2, S3, S4, Sn.

The toolset organizer 20 facilitates organizing the sockets to facilitate identification and removal of an induvial socket. That is, the connectors can also be individually separated to access individual sockets.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

While various inventive aspects, concepts and features of the general inventive concepts are described and illustrated herein in the context of various exemplary embodiments, these various aspects, concepts, and features may be used in many alternative embodiments, either individually or in various combinations and sub-combinations thereof

Unless expressly excluded herein all such combinations and sub-combinations are intended to be within the scope of the general inventive concepts. Still further, while various alternative embodiments as to the various aspects, concepts, and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed.

Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary, or representative values and ranges may be included to assist in understanding the present disclosure; however, such values and ranges are not to be construed in a limiting sense and are intended to be critical values or ranges only if so expressly stated.

Moreover, while various aspects, features and concepts may be expressly identified herein as being inventive or forming part of an invention, such identification is not intended to be exclusive, but there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A first connector of a toolset organizer for organizing sockets, comprising:
a first male polygon section connector body along an axis, the first male polygon section connector body sized to receive a first socket;
a second male polygon section connector body along the axis, the second male polygon section connector body sized to receive a second socket; and
a first flange along the axis between the first male polygon section connector body and the second male polygon section connector body, the first flange of diameter greater than that of the first male polygon section connector body and the second male polygon section connector body.

2. The first connector as recited in claim 1, wherein the first flange comprises a magnetic material.

3. The first connector as recited in claim 1, further comprising a magnet within the first flange.

4. The first connector as recited in claim 1, further comprising a multiple of magnets within the first flange.

5. The first connector as recited in claim 1, wherein the first male polygon section connector body is of a size different than the second male polygon section connector body.

6. The first connector as recited in claim 1, wherein the first socket is of a size different than the second socket.

7. The first connector as recited in claim 1, wherein the first male polygon section connector body is sized to receive a first socket via an interference fit and the second male polygon section connector body is sized to receive a second socket via an interference fit.

8. The first connector as recited in claim 1, wherein the first male polygon section connector body comprises a first number of sides and the second male polygon section connector body comprises a second number of sides different than the first number of sides.

9. The first connector as recited in claim 1, wherein the first male polygon section connector body comprises six sides and the second male polygon section connector body comprises four sides.

10. A toolset organizer for organizing sockets, the toolset organizer comprising:
a first of a multiple of connectors each comprising a first flange along an axis between a first male polygon section connector body and a second male polygon section connector body, the first flange of a diameter greater than that of the first male polygon section connector body and the second male polygon section connector body,
wherein the first male polygon section connector body is sized to receive a first socket;
wherein the second male polygon section connector body is sized to receive a second socket different in size than the first socket; and
a second of the multiple of connectors each comprising a second flange along the axis between a third male polygon section connector body and a fourth male polygon section connector body, the second flange of a diameter greater than that of the third male polygon section connector body and the fourth male polygon section connector body, the third male polygon section connector body of the same size as the second male polygon section connector body.

11. The toolset organizer as recited in claim 10, wherein each of the first male polygon section connector body and the second male polygon section connector body comprises a hexagon different in size to receive only a single respective socket.

12. The toolset organizer as recited in claim 10, wherein first flange and the second flange are of an equivalent diameter.

13. The toolset organizer as recited in claim 10, wherein first flange and the second flange each comprises a magnetic material.

14. The toolset organizer as recited in claim 10, wherein first flange and the second flange each contain a magnet.

15. The toolset organizer as recited in claim 10, wherein first flange and the second flange each contain a multiple of magnets.

16. The toolset organizer as recited in claim 10, wherein the first male polygon section connector body is of a size different than the second male polygon section connector body.

17. The toolset organizer as recited in claim 10, wherein the third male polygon section connector body is of a size different than the fourth male polygon section connector body.
